(19) United States
(12) Patent Application Publication
(10) Pub. No.: US 2009/0280379 A1
(43) Pub. Date: Nov. 12, 2009

(54) Electrode binder solution composition for polymer electrolyte fuel cell

(75) Inventors: Ki Yun Cho, Seoul (KR); Jung Ki Park, Daejeon (KR); Ho Young Jung, Daejeon (KR); Kyung A. Sung, Daejeon (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Korea Advanced Institute of Science and Technology, Daejeon (KR)

(21) Appl. No.: 12/288,301

(22) Filed: Oct. 17, 2008

(30) Foreign Application Priority Data
May 6, 2008 (KR) 10-2008-0041741

(51) Int. Cl. H01M 8/00

(52) U.S. Cl. 429/33

(57) ABSTRACT

The present invention relates to an electrode binder solution composition for a polymer electrolyte fuel cell comprising a mixture of a solvent and a nonsolvent. The electrode binder solution composition can significantly improve electrode activity by maximizing formation of a three-phase interface of catalyst, binder and fuel at the electrode catalytic layer of the polymer electrolyte fuel cell. The present invention relates to a preparation method of an electrode binder solution for a polymer electrolyte fuel cell, the electrode binder solution for a polymer electrolyte fuel cell comprising a sulfonated proton exchange hydrocarbon-based polymer and a mixture of a solvent and a nonsolvent. The present invention also relates to a preparation method of an electrode catalyst slurry comprising the steps of: mixing an electrode binder solution composition for a polymer electrolyte fuel cell with a platinum catalyst and drying the mixture; and heat-treating the dried mixture to maximize interface between the electrode binder and the catalyst.

### CROSS-REFERENCE TO RELATED APPLICATION

This application claims under 35 U.S.C. §119(a) the benefit of Korean Patent Application No. 10-2008-0041741 filed May 6, 2008, the entire contents of which are incorporated herein by reference.

1. Technical Field

The present disclosure relates to an electrode binder solution composition for a polymer electrolyte fuel cell comprising a mixture of a solvent and a nonsolvent, which can significantly improve electrode activity by maximizing formation of a three-phase interface of catalyst, binder and fuel at the electrode catalytic layer of the polymer electrolyte fuel cell. The present invention relates to a preparation method of an electrode binder solution for a polymer electrolyte fuel cell, the electrode binder solution for a polymer electrolyte fuel cell comprising a sulfonated proton exchange hydrocarbon-based polymer and a mixture of a solvent and a nonsolvent. The present invention also relates to a preparation method of an electrode catalyst slurry comprising the steps of: mixing an electrode binder solution composition for a polymer electrolyte fuel cell with a platinum catalyst and drying the mixture; and heat-treating the dried mixture to maximize interface between the electrode binder and the catalyst.

2. Background Art

The world is now in the big wave of “energy war.” Advanced countries are fostering trades and cooperation with the countries rich in fossil energy resources in order to ensure consistent economic development and comfortable lives of their people. However, fossil energy resources might be depleted within years. Further, because of ever-increasing oil price and environmental pollution caused by the use of fossil energy, interests in alternative energy source are increasing. Of the potential alternative energy sources, hydrogen is the most abundant in the earth and is environment-friendly. Recently, researches on hydrogen energy have been increasing rapidly. “Fuel cell” is in the heart of such efforts.

A fuel cell is a device that generates electrical energy by electronically converting chemical energy derived from a fuel directly into electrical energy by oxidation of the fuel. Basically, a fuel cell has the structure of a membrane electrode assembly (MEA) consisting of a fuel electrode containing a catalyst, an oxygen electrode and an electrolyte membrane disposed between the two electrodes.

The performance of MEA is greatly dependent on the performance of each electrode. The performance of the electrode, in turn, varies significantly depending on the three-phase interface formed by the catalyst, binder and fuel. Accordingly, the control of the three-phase interface at the electrode catalytic layer is considered as the key factor directly related with the performance of the fuel cell.

One approach to improve the performance of MEA was to use a hydrocarbon-based polymer as an electrode binder (Korean Patent No. 10-0815117). This approach, however, has drawbacks in that cohesion of the electrode catalytic layer occurs as the hydrocarbon-based polymer is dissolved in a polar solvent and introduced to the electrode and that the hydrocarbon-based polymer does not form particles. For these reasons, three-phase interface formation is reduced, thereby decreasing the electrode activity and MEA performance significantly.

Another approach was to use sulfonated polyetheretherketone (“S-PEEK”) dissolved in dimethylacetamide (DMAc) in the ratio of 5 wt % (J. K. Park et al., JPS 163, 2006, 56.) or sulfonated polyaryleneethersulfone (“S-PAES”) dissolved in DMAc in the ratio of 5 wt % (J. K. Park et al., Electrochimica Acta 52, 2007, 4916) as an electrode binder solution. Although this approach improved the interfacial stability of the membrane and electrode as the electrode binder solution comprises the same material as the proton exchange polymer electrolyte membrane, it still has a drawback in that cohesion between the catalyst and the polymer dissolved in the polar solvent occurs, decreasing the performance of the electrode and MEA.

Accordingly, there is a need for development of a technique that can improve electrode activity by maximizing formation of a three-phase interface of catalyst, binder and fuel.

### SUMMARY

In an aspect, the present invention provides an electrode binder solution composition for a polymer electrolyte fuel cell comprising: 5-40 weight % of a sulfonated proton exchange hydrocarbon-based polymer; and 60-95 weight % of a mixture of a solvent and a nonsolvent.

In another aspect, the present invention provides a method for preparing the electrode binder solution for a polymer electrolyte fuel cell.

The present invention provides the advantageous effect that, by introducing a nonsolvent, cohesion of the electrode binder and the nonsolvent is induced in the electrode binder composition to form nanometer sized particles, thereby increasing electrode active surface area, and formation of a three-phase interface of catalyst, binder and fuel is maximized, thereby preventing cohesion between the polymer dissolved in the solvent and the catalyst and improving electrode activity.

The above and other features will be discussed infra.

### BRIEF DESCRIPTION OF DRAWINGS

The above and other objects, features and other advantages of the present invention will be more clearly understood from the following detailed description taken in conjunction with the accompanying drawings, in which:

FIG. 1 schematically illustrates the formation of a three-phase interface in the electrode binder solution for a polymer electrolyte fuel cell according to the present invention, in which binder solution a mixture of a solvent and a nonsolvent is included;

FIG. 2 shows particle size distribution of the electrode binder measured in Test Example 1;

FIG. 3 shows a surface structure of the electrode binder composition prepared in Preparation Example 2; and

FIG. 4 shows a surface structure of the electrode binder composition prepared in Comparative Preparation Example 2.

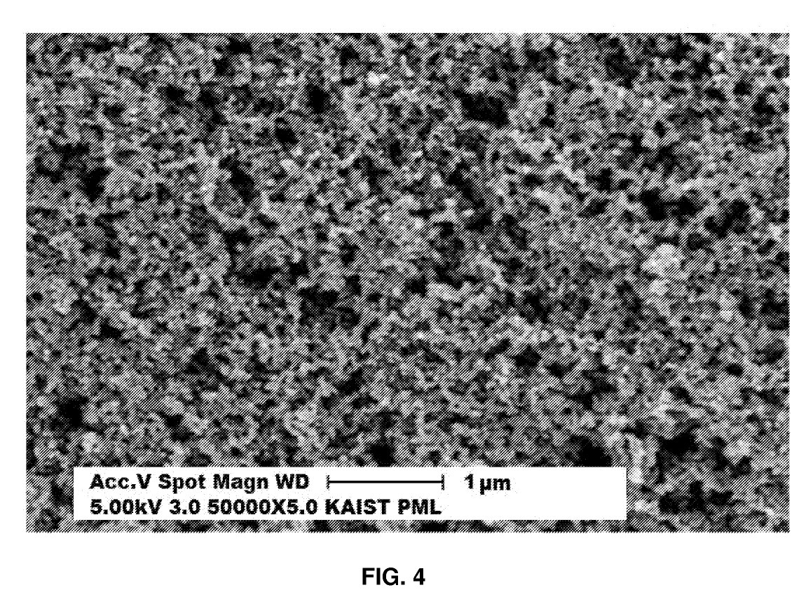

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

In one aspect, as discussed above, the present invention provides an electrode binder solution composition for a polymer electrolyte fuel cell.

The electrode binder solution composition for a polymer electrolyte fuel cell according to the present invention comprises 5-40 wt % of a sulfonated proton exchange hydrocarbon-based polymer; and 60-95 wt % of a mixture of a solvent and a nonsolvent.

When the hydrocarbon-based polymer is included in an amount less than 5 wt % based on the total weight of the electrode binder solution composition, cell performance may decrease because of reduced proton conductivity. On the other hand, when it is included in an amount exceeding 40 wt %, cell performance may decrease because supply of fuel may become difficult.

When the mixture solvent is included in an amount less than 60 wt % based on the total weight of the electrode binder solution composition, catalyst dispersibility may decrease. On the other hand, if the mixture solvent is included in an amount exceeding 95 wt %, preparation of electrode may become difficult due to low viscosity.

As used in the present description, the term “solvent” refers to a solvent that dissolves the proton exchange hydrocarbon-based polymer well, and the term “nonsolvent” refers to a solvent that cannot dissolve or can hardly dissolve the proton exchange hydrocarbon-based polymer.

Preferably, the sulfonated proton exchange hydrocarbon-based polymer may include, but not limited to, polysulfone, polyaryleneethersulfone, polyetherethersulfone, polyimide, polyimidazole, polybenzimidazole, polyetherbenzimidazole, polyaryleneetherketone, polyetheretherketone, polyetherketone, polyetherketoneketone, polystyrene or any combination thereof. It should, however, be noted that other polymers may be used as long as they have superior proton conductivity.

The sulfonated proton exchange hydrocarbon-based polymer may have a degree of sulfonation of 10-80 mol %, preferably 20-70 mol %, more preferably 30-60 mol %. When the degree of sulfonation of the proton exchange hydrocarbon-based polymer is below 10 mol %, proton conductivity may decrease. By contrast, when it exceeds 80 mol %, long-term stability may decrease because the polymer becomes soluble in water.

Further, the sulfonated proton exchange hydrocarbon-based polymer may have a number average molecular weight of 1,000 to 1,000,000, more preferably 5,000 to 500,000. When the number average molecular weight of the polymer is smaller than 1,000, stability of the polymer may decrease. In contrast, when it exceeds 1,000,000, solubility may decrease.

In addition, the sulfonated proton exchange hydrocarbon-based polymer may have a weight average molecular weight of 10,000 to 1,000,000, more preferably 100,000 to 800,000. When the weight average molecular weight of the polymer is smaller than 10.000, stability of the polymer may decrease. On the other hand, when it exceeds 1,000,000, solubility may decrease.

The mixture solvent, another component of the binder solution composition, comprises 90-99.9 wt % of a solvent and 0.1-10 wt % of a nonsolvent. When the content of the nonsolvent is below 0.1 wt %, dispersed particles may not be formed easily. In contrast, when it exceeds 10 wt %, proton conductivity may decrease because of increased particle size.

When mixing the solvent with the nonsolvent, there are many factors to be considered because particle size changes greatly depending on the ratio of the solvent and the nonsolvent, the properties of the solvent and the nonsolvent, the property (e.g., polarity) of the polymer, and the like. If the nonsolvent characteristics are too strong or the amount of the nonsolvent is too much, particle size may become excessively large. On the other hand, if the amount of the solvent is too much or the solvent characteristics are too strong, particles may not be formed. Further, when the solvent and the nonsolvent are not mixed with each other, control of particle size becomes difficult. As described above, there are a lot of technical difficulties in preparing a mixture of the solvent and the nonsolvent. According to the present invention, such difficulties are resolved by adjusting the mixing ratio of the solvent and the nonsolvent, and selecting the following solvent and nonsolvent.

The solvent of the mixture serves to dissolve the sulfonated hydrocarbon-based proton exchange polymer material. Examples of the solvent may include, but not limited to, N-methylpyrrolidone (NMP), dimethylformamide (DMF), dimethylacetamide (DMAc), dimethyl sulfoxide (DMSO), ethanol, and any combination thereof. It should be noted that any solvent that can dissolve the sulfonated hydrocarbon-based proton exchange polymer material may be used.

The nonsolvent of the mixture serves to form particles of the sulfonated hydrocarbon-based proton exchange polymer material. Non-limiting examples of the nonsolvent may include acetone, tetrahydrofuran (THF), isopropyl alcohol, acetic acid, methanol and any combination thereof.

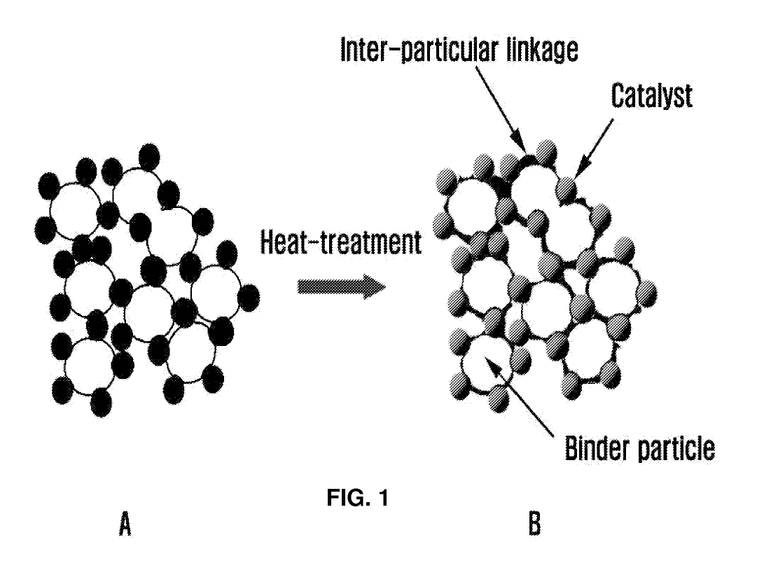

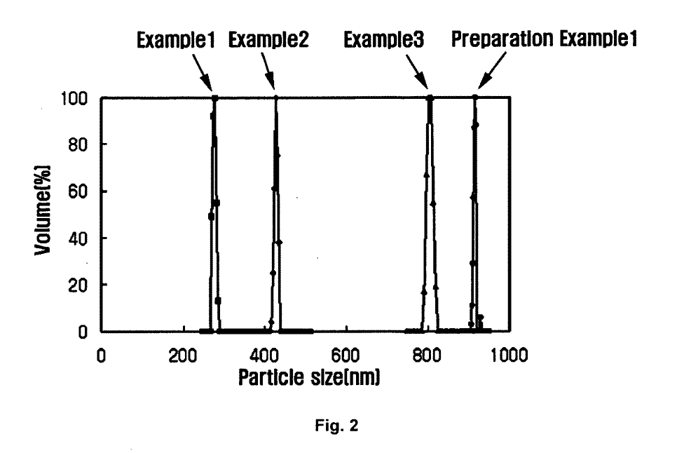

In the electrode binder solution composition for a polymer electrolyte fuel cell according to the present invention, the sulfonated proton exchange hydrocarbon-based polymer material may have an average particle size of 1-400 nm, preferably 50-380 nm, more preferably 100-350 nm. The average particle size may be controlled by varying the weight ratio of the solvent and the nonsolvent of the mixture solvent. For example, increasing the weight ratio of the nonsolvent in the mixture solvent results in increased average particle size of the sulfonated hydrocarbon-based proton exchange polymer material, which is confirmed in FIG. 2. Further, by introducing a nonsolvent, differently from the conventional electrode binder solutions for a polymer electrolyte fuel cell which comprise a hydrocarbon-based polymer material and a solvent, a three-phase interface is formed as illustrated in FIG. 1 as the hydrocarbon-based polymer material is formed into particles. As a result, electrode activity is improved because the binding with catalyst becomes facile.

In another aspect, the present invention provides a preparation method of an electrode binder solution for a polymer electrolyte fuel cell, the electrode binder solution for a polymer electrolyte fuel cell comprising a sulfonated proton exchange hydrocarbon-based polymer and a mixture of a solvent and a nonsolvent.

In still another aspect, the present invention provides a preparation method of an electrode catalyst slurry comprising the steps of: mixing an electrode binder solution composition for a polymer electrolyte fuel cell with a platinum catalyst and drying the mixture; and heat-treating the dried mixture to maximize interface between the electrode binder and the catalyst.

Excellent proton conductivity can be attained when binder particles are bound well with one another. The binder solution composition for a polymer electrolyte fuel cell may have discontinuous inter-particular linkage, as shown in FIG. 1A. In accordance with an embodiment of the present invention, heat-treatment is carried out following addition of catalyst to the binder composition and drying. As the binder particle is partly melted, a linkage is formed as shown in B of FIG. 1. As inter-particular linkages between binder particles increase, proton conductivity increases and fuel cell performance is improved.

Preferably, the drying is carried out at 75-85° C. And, the heat-treatment is carried out at 130-200° C., more preferably at 140-160° C., for about 30 minutes to 2 hours.

The components of the electrode binder solution and the proportion of the components are the same as those described above with respect to the electrode binder solution composition for a polymer electrolyte fuel cell.

Hereinafter, the present invention is described in more detail referring to the following examples. However, the scope of the present invention is not limited by the examples.

### EXAMPLES

Preparation of Sulfonated Proton Exchange Hydrocarbon-Based Polymer

Polyetheretherketone was sulfonated in strong sulfuric acid as follows. After adding 50 mL of 98% sulfuric acid in a 100 mL round-bottom flask, purging with nitrogen, and drying at 100° C. for 24 hours in vacuum, 2 g of polyetheretherketone polymer was added and vigorous stirring was performed at 50° C. After 6-24 hours of sulfonation, the reaction mixture was precipitated in distilled water and filtered. After washing several times with water and neutralizing to pH 6-7, the reaction mixture was filtered again. Thus obtained product was dried at 50° C. for 24 in vacuum. 50% sulfonated polyetheretherketone polymer was obtained. Number average molecular weight of the sulfonated polyetheretherketone polymer was 25,000.

Preparation of Electrode Binder Solution Composition

### Example 1

A mixture solvent comprising 97 wt % of DMAc (solvent) and 3 wt % of acetic acid (nonsolvent) was prepared.

An electrode binder solution composition for a polymer electrolyte fuel cell was prepared using 5 wt % of the sulfonated polyetheretherketone polymer and 95 wt % of the mixture solvent prepared above.

### Examples 2-3 and Comparative Examples 1-2

An electrode binder solution composition for a polymer electrolyte fuel cell was prepared in the same manner as in Example 1 by varying compositions of the mixture solvent as in the following Table 1.

TABLE 1

| | Mixture solvent | | |
|---|---|---|---|
| | DMAc | Acetic acid | Refractive index |
| Example 1 | 97 | 3 | 1.438 |
| Example 2 | 95 | 5 | 1.435 |
| Example 3 | 90 | 10 | 1.432 |
| Comparative Example 1 | 87 | 13 | 1.431 |
| Comparative Example 2 | 100 | — | 1.439 |

Refractive index of a mixture of solvent and nonsolvent is a measure of compatibility of the solvent and the nonsolvent. The fact that the refractive index changed in proportion to the mixing proportion indicates that the solvent and the nonsolvent are compatible with each other.

### Test Example 1

Particle size of each of the electrode binder of the electrode binder solution compositions for a polymer electrolyte fuel cell prepared in Examples 1-3 and Comparative Examples 1-2 was measured by DLS (dynamic light scattering). The result is shown in FIG. 2.

As seen in FIG. 2, average particle size of the hydrocarbon electrode binder in the solution composition prepared using a mixture solvent comprising 97 wt % of DMAc and 3 wt % of acetic acid (Example 1) was 140-145 nm (Example 2: 210-220 nm, Example 3: 395-400 nm, Comparative Example 1: 460-470 nm). That is, particle size in the binder solution increased in proportion to the weight portion of the nonsolvent in the mixture solvent. And, particle was not formed in Comparative Example 2, in which nonsolvent was not added. Thus, it can be confirmed that addition of nonsolvent is required to form electrode binder particles in the electrode solution. Also, it is confirmed that the particle size can be controlled by varying the weight ratio of solvent and nonsolvent.

### Preparation Example 1

Platinum catalyst (20% Pt/C catalyst, E-Tek) was added to the binder solution composition for a polymer electrolyte fuel cell prepared in Example 1, and dried at 80° C. Then, electrode catalyst slurry was prepared by heat-treating at 150° C. for 1 hour. The prepared catalyst slurry was maintained in uniformly dispersed state by repeating ultrasonication and agitation for 24 hours, and was cast on carbon fiber at a supporting amount of 0.1 mg Pt/cm².

### Preparation Examples 2-3 and Comparative Preparation Examples 1-2

Electrode catalyst slurry was prepared in the same manner as Preparation Example 1 using the binder solution compositions for a polymer electrolyte fuel cell prepared in Examples 2-3 and Comparative Examples 1-2, and was cast on carbon fiber at a supporting amount of 0.1 mg Pt/cm².

### Test Example 2

Measurement of Fuel Cell Electrode Active Surface Area

For each of the electrode catalyst slurries prepared in Preparation Examples 1-3 and Comparative Preparation Example 1-2, fuel cell electrode active surface area was measured as follows by the CV (cyclovoltammetry) method.

MEA was constructed using a fuel cell cathode (reference electrode) coated with platinum catalyst and a nafion membrane. While supplying hydrogen at the cathode and nitrogen at the anode (working electrode), at a rate of 50 cc/min, CV measurement was made using FRA (frequency response analyzer, Solatron). Hydrogen oxidation peak at around 0.2 V was integrated. The result is given in the following Table 2. CV scan voltage range was from 0 to 1.2 V. And, scan rate was 1 0 mV/sec.

TABLE 2

| | Electrochemical active |
|---|---|
| | surface area (m²/g Pt) |
| Preparation Example 1 | 51.8 |
| Preparation Example 2 | 53.1 |
| Preparation Example 3 | 51.2 |
| Comparative Preparation Example 1 | 44.7 |
| Comparative Preparation Example 2 | 46.5 |

As seen in Table 2, electrochemical active surface area was larger when the binder composition for a polymer electrolyte fuel cell according to the present invention was used (Preparation Examples 1-3) than when the conventional binder composition for a polymer electrolyte fuel cell was used (Comparative Preparation Example 2). When the size of dispersed particles was larger than 400 nm (460-470 nm, Comparative Preparation Example 1), electrode surface area was smaller even that of Comparative Preparation Example 2. That is, electrode activity decreases when the size of dispersed particles exceeds 400 nm. While not intending to limit the theory, it may be because the three-phase interface decreases as the particle size of the electrode binder increases. Therefore, it was confirmed that preferable size of the dispersed electrode binder particles in the binder composition for a polymer electrolyte fuel cell according to the present invention is from 1 to 400 nm.

### Test Example 3

Measurement of Surface Area of Fuel Cell Electrode

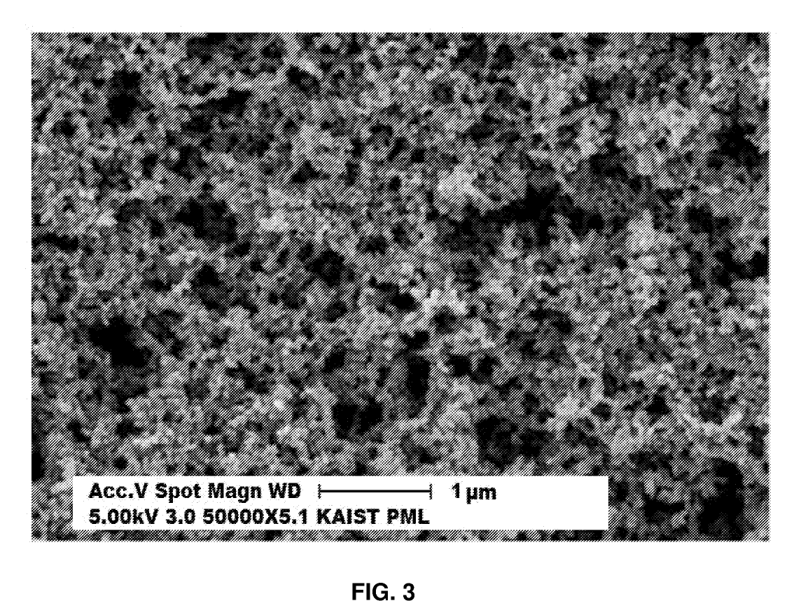

Surface of the electrode catalyst slurry prepared using the electrode binder composition for a polymer electrolyte fuel cell according to the present invention (Preparation Example 2) was compared with that prepared using the conventional electrode binder composition for a polymer electrolyte fuel cell (Comparative Preparation Example 2) in FIG. 3.

As seen in the figure, the electrode surface in which the polymer electrolyte binder composition according to the present invention was added is porous and, thus, is advantageous in transfer of materials. On the contrary, the electrode surface in which the conventional hydrocarbon-based polymer electrolyte binder was added (Comparative Preparation Example 2) has a dense structure and, thus, is disadvantageous in transfer of fuel.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An electrode binder solution composition for a polymer electrolyte fuel cell comprising:
5-40 weight % of a sulfonated proton exchange hydrocarbon-based polymer; and
60-95 weight % of a mixture of a solvent and a nonsolvent.

2. The electrode binder solution composition for a polymer electrolyte fuel cell as set forth in claim 1, wherein the sulfonated proton exchange hydrocarbon-based polymer has a degree of sulfonation of 10-80 mol %.

3. The electrode binder solution composition for a polymer electrolyte fuel cell as set forth in claim 1, wherein the polymer is prepared by sulfonating at least one polymer selected from polysulfone, polyaryleneethersulfone, polyetherethersulfone, polyimide, polyimidazole, polybenzimidazole, polyetherbenzimidazole, polyaryleneetherketone, polyetheretherketone, polyetherketone, polyetherketoneketone and polystyrene.

4. The electrode binder solution composition for a polymer electrolyte fuel cell as set forth in claim 1, wherein the sulfonated proton exchange hydrocarbon-based polymer has a number average molecular weight of 1,000 to 1,000,000 and a weight average molecular weight of 10,000 to 1,000,000.

5. The electrode binder solution composition for a polymer electrolyte fuel cell as set forth in claim 1, wherein the solvent is at least one selected from N-methylpyrrolidone (NMP), dimethylformamide (DMF), dimethylacetamide (DMAc), dimethyl sulfoxide (DMSO) and ethanol.

6. The electrode binder solution composition for a polymer electrolyte fuel cell as set forth in claim 1, wherein the nonsolvent is at least one selected from acetone, tetrahydrofuran (THF), isopropyl alcohol, acetic acid and methanol.

7. The electrode binder solution composition for a polymer electrolyte fuel cell as set forth in claim 1, wherein the mixture solvent comprises 90-99.9 wt % of the solvent and 0.1-10 wt % of the nonsolvent.

8. The electrode binder solution composition for a polymer electrolyte fuel cell as set forth in claim 1, wherein the hydrocarbon binder included in the binder solution composition has an average particle size of 1-400 nm.

9. A preparation method of an electrode binder solution for a polymer electrolyte fuel cell, the electrode binder solution for a polymer electrolyte fuel cell comprising a sulfonated proton exchange hydrocarbon-based polymer and a mixture of a solvent and a nonsolvent.

10. A preparation method of an electrode catalyst slurry comprising the steps of: mixing an electrode binder solution composition for a polymer electrolyte fuel cell with a platinum catalyst and drying the mixture; and heat-treating the dried mixture to maximize interface between the electrode binder and the catalyst.

11. The preparation method of an electrode catalyst slurry according to claim 10, wherein the drying is carried out at 75-85° C.

12. The preparation method of an electrode catalyst slurry according to claim 10, wherein the heat-treatment is carried out at 130-200° C., more preferably at 140-160° C., for about 30 minutes to 2 hours.
